(19) United States
(12) Patent Application Publication
(10) Pub. No.: US 2004/0102246 A1
(43) Pub. Date: May 27, 2004

(54) Handheld controller with LCD

(75) Inventor: Andy Kam Kong Chan, Fanling (HK)

Correspondence Address: Thomas E Sisson, Jackson Walker LLP, 112 E Pecan Street Suite 2100, San Antonio, TX, 78205, US

(73) Assignee: Esel Interantional Co., Ltd., New Territories (HK)

(21) Appl. No.: 10/301,619

(22) Filed: Nov. 22, 2002

(51) Int. Cl. A63F 13/02

(52) U.S. Cl. 463/36

(57) ABSTRACT

A control unit for a video game has user-manipulable controls, a display panel, and an input connector via which the display panel receives video signals from an external source. The control unit is useful where a television set is unavailable for use with the video game.

### BACKGROUND OF THE INVENTION

The present invention relates to a handheld controller having a display panel. More particularly, although not exclusively, the invention relates to a handheld game controller having a pivotable LCD panel that receives video signals from an external source.

Electronic television games are known to comprise apparatus attached to the television via the TV's antenna input or AV input socket. Modern electronic game machines such as the Sony PlayStation®, PlayStation 2®, Microsoft XBox® and Nintendo GameCube®, have a game console into which a game-specific DVD is received and within which there is a processor for generating video and sound signals to be transmitted to the television. The console receives input from, and sometimes transmits feedback signals to, one or more control panels, each having say a steering wheel, a gear change selector, a pointing device etc, for a single player or multiple game players. There might also be included for the one or each player a throttle and a brake pedal input unit for example. All the input devices are attached to the console.

When playing games with such machines, the television is monopolised by the game player or players. However, if the television is to be used for normal viewing—usually by somebody other than the game player(s), the game must cease.

Also, the sound effects generated by the processor must be relayed through the television's speakers, or speakers forming part of an AV system with which the television might ordinarily be associated. Clearly, a television programme for example cannot be viewed by one or more individuals, whilst other individuals in the same room are playing video games using the same AV equipment.

### OBJECTS OF THE INVENTION

It is an object of the present invention to overcome or substantially ameliorate at least one of the above disadvantages and/or more generally to provide a handheld controller for a video game machine, wherein the controller has a display panel attached thereto or formed integrally therewith for displaying video signals received from an external source.

### DISCLOSURE OF THE INVENTION

There is disclosed herein a handheld video game control unit, comprising:

user-manipulable controls,

a control signal output via which control signals generated by the controls are transmitted by the unit to a game console,

a display panel, and

an input via which the display panel receives video signals from an external source.

Preferably, the control unit further comprises speakers and/or an earphone/headphone jack for audio signals received via said or another input.

Preferably, the control unit further comprises a base unit to which the display panel is attached by a pivot connection.

More preferably, there is associated with the pivot connection a locking device for locking the display panel at one of a number of selected orientations with respect to the base unit.

In a preferred embodiment, the control unit includes a shaft between the display panel and the base unit, and a clutching device for locking the display panel against pivotal movement with respect to the base unit. A pushbutton is provided at each end of the shaft, by which the shaft is movable longitudinally to operate the clutching device to enable pivotal movement of the display panel with respect to the base unit.

More preferably, the clutching device comprises a spline fixed relative to one of the base unit and display panel, and a number of clutching fingers fixed relative to the other of the display panel and base unit. The fingers are engageable with one of the pushbuttons to bear against the spline when the shaft is moved longitudinally.

There is further disclosed herein a video game system comprising:

the above-disclosed control unit, and

a game console having a video output transmitting video information to the input of the control unit, and a control signal input receiving control signals from the control signal output of the control unit.

### BRIEF DESCRIPTION OF THE DRAWINGS

A preferred form of the present invention will now be described by way of example with reference to the accompanying drawings, wherein:

FIG. 1 is a perspective and partially cross-sectional view of a video game control unit having a display panel attached hingedly to a base unit with a locking device, associated with the hinge in a position locking against pivotal movement of the display panel;

FIG. 1A is a cross-sectional view on an enlarged scale showing the locking device of FIG. 1;

FIG. 1B is a perspective view showing the locking device of FIG. 1;

FIG. 2 is a perspective and partially cross-sectional view of the video game control unit of FIG. 1 having the locking device in a position enabling pivotal movement of the display panel;

FIG. 2A is a cross-sectional view on an enlarged scale showing the locking device of FIG. 2;

FIG. 2B is a perspective view showing the locking device of FIG. 2;

FIG. 3 is a side elevational view of the control unit of FIG. 1 or 2;

FIG. 4 is a close-up view of the hinge by which the display panel of the control unit is attached to the base unit;

FIG. 5 is an exposed perspective view of the control unit of FIG. 1 or 2;

FIG. 6 is a schematic diagram showing the control unit of FIG. 1 or 2 attached to a Sony PlayStation 2® console via both an AV cable and a control cable;

FIG. 7 is a top plan view of the control unit of FIG. 1 or 2;

FIG. 8 is a close-up view of a lower portion of the display panel of FIG. 1 or 2;

FIG. 9 is a view depicting stereo speakers positioned on both sides of the display panel of FIG. 1 or 2;

FIG. 10 is a fragmentary side elevational view of the display panel and hinge of FIG. 1 or 2;

FIG. 11 is a side elevational sequence diagram of the control unit of FIG. 1 or 2 in various stages of pivotal movement of the display panel; and

FIG. 12 is a schematic diagram showing a multi-player system having a number of the control units of FIG. 1 or 2 linked to a Sony PlayStation 2® console.

### DESCRIPTION OF THE PREFERRED EMBODIMENT

In the accompanying drawings, there is depicted schematically a control unit or controller 10 for a video game. Control unit 10 comprises a base unit 11 to which there is hingedly attached a display panel 12. Details of the hinge 13 between the base unit 11 and the display panel 12 will be described later.

The base unit 11 has a pair of grasping portions 14 to be grasped by a player in his or her left and right hands respectively. A protrusion 11A upstanding centrally from a rear periphery of the base unit 11 constitutes one part of the hinge 13. The protrusion 11A is formed, at its opposite left and right ends, with a pair of annular grooves 11AA.

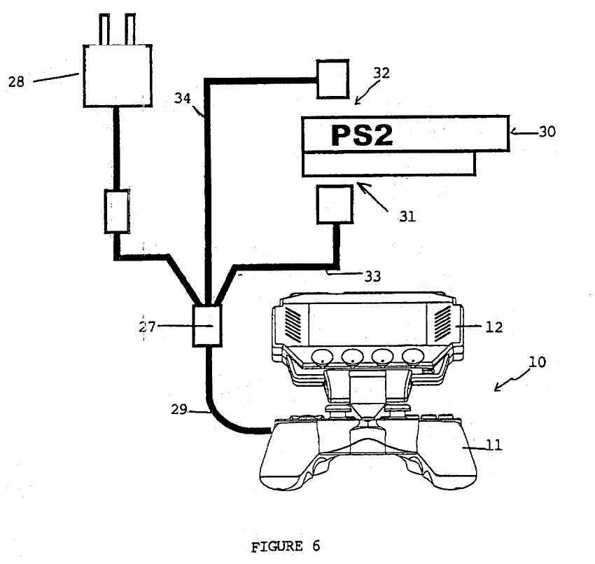

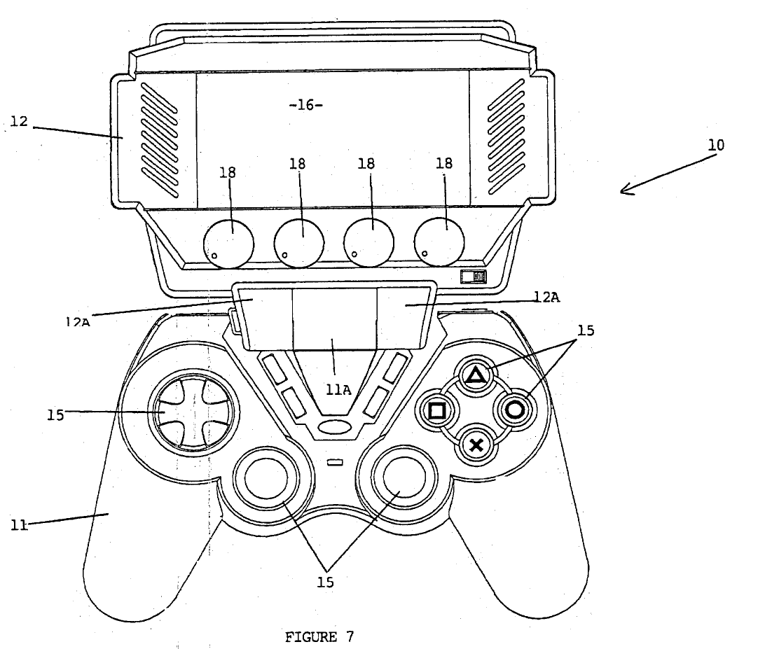

Control buttons and toggles 15 are provided upon an upper surface of the base unit 11 for controlling output signals generated by the control unit. These toggles and buttons 15 are designated “Turbo”, “select”, “analog”, “start”, “clear”, etc. The signals manipulated by these keys are transmitted from the control unit 10 via a cord 29 (FIG. 6). Alternatively however, control signals could be transmitted by an infrared light transmitting diode or RF transmission for example or other means of transmission. The signals are to be received by a game console such as a Sony PlayStation 2®.

The display panel 12 has a visible area 16 that displays video signals received via cord 29 from an external source. The external source is typically the same console that receives the control signals via cord 29. There are stereo speakers 17 flanking the display area 16. Just below the display area 16, there are display and volume controls 18, which are typically designated “volume”, “colour”, “brightness” and “contrast” for example.

A pair of hollow legs 12A depending symmetrically from a bottom periphery of the display panel 12 constitutes the other part of the hinge 13. The two legs 12A flank the protrusion 11A and enclose its left and right ends respectively. Each leg 12A includes an apertured inner wall that engages around, and within, the corresponding annular end groove 11AA of the protrusion 11A, such that the display unit 12 is pivotable with regard to the base unit 11 about a horizontal hinge axis.

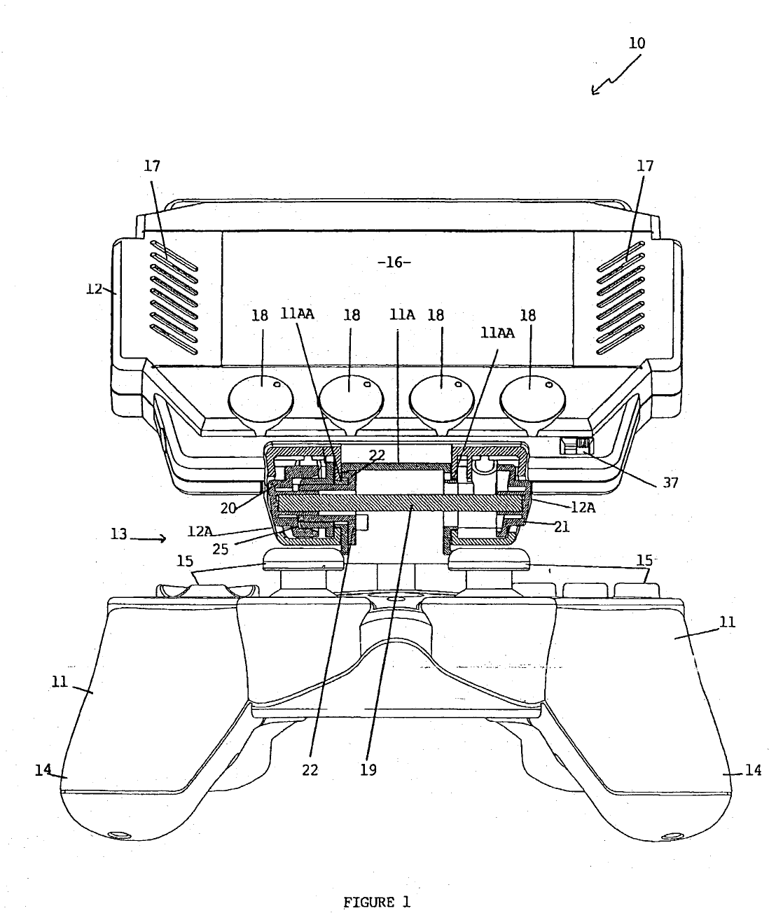

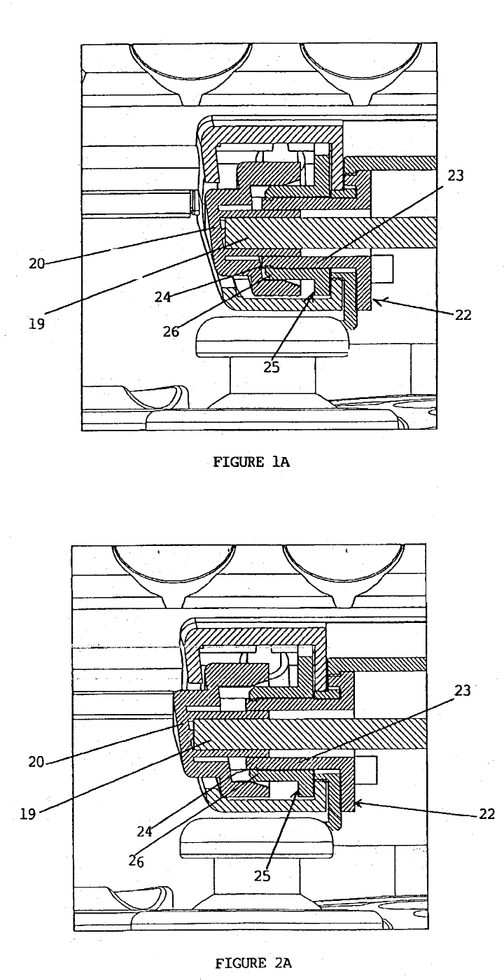

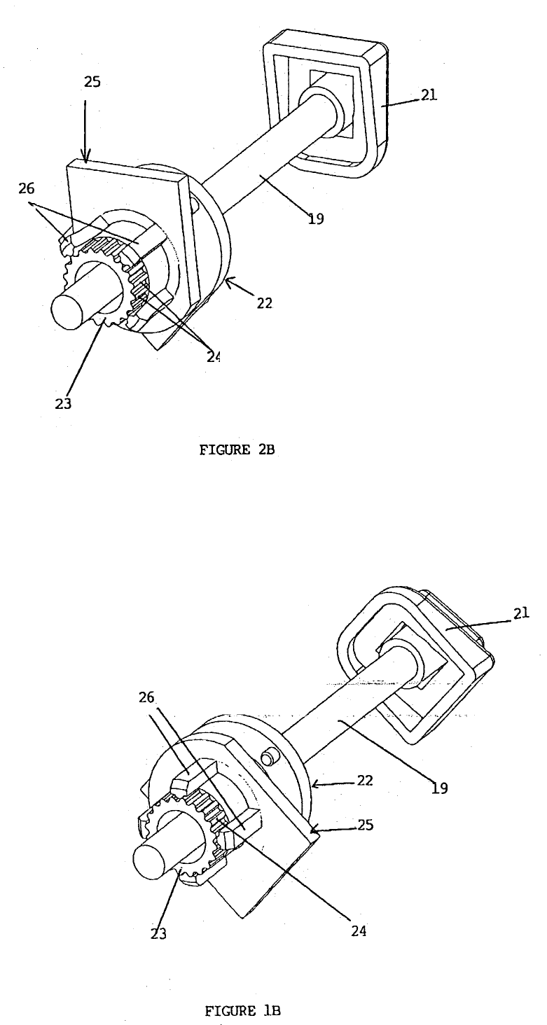

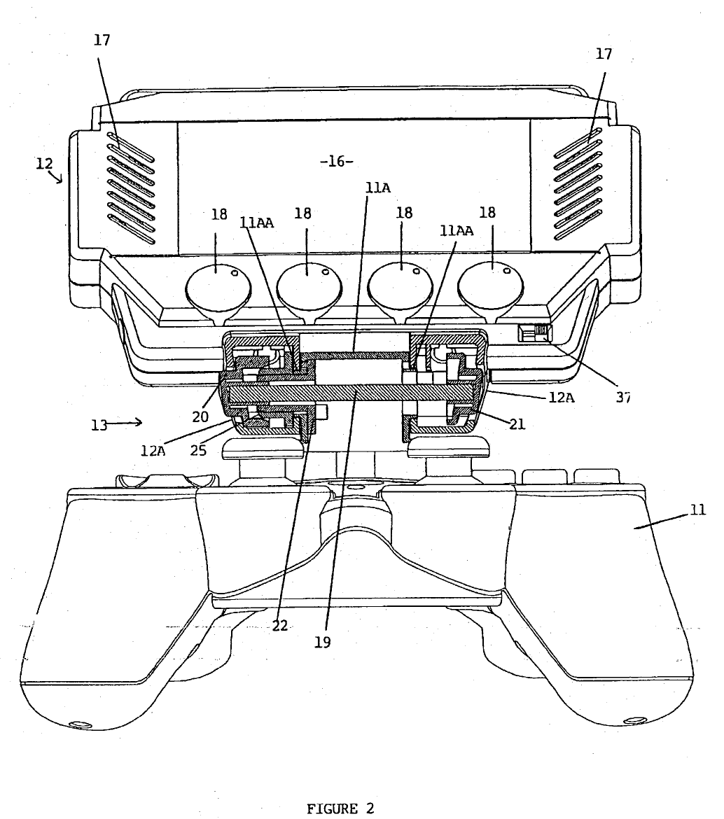

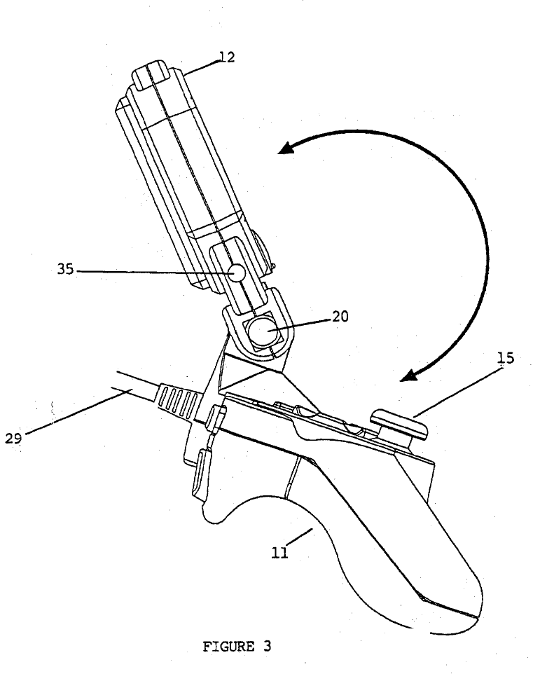

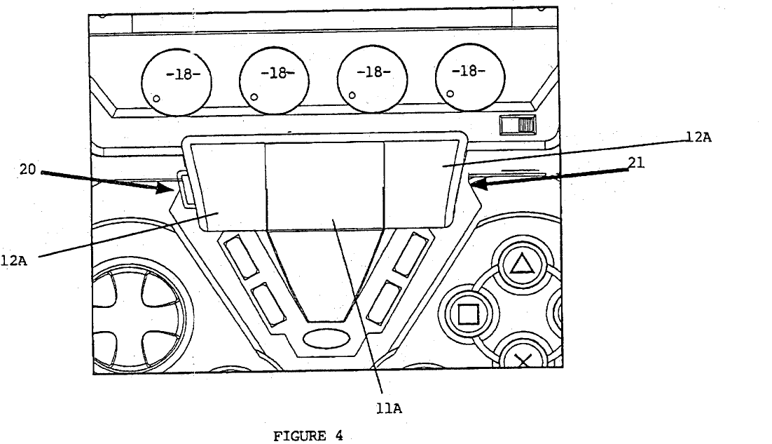

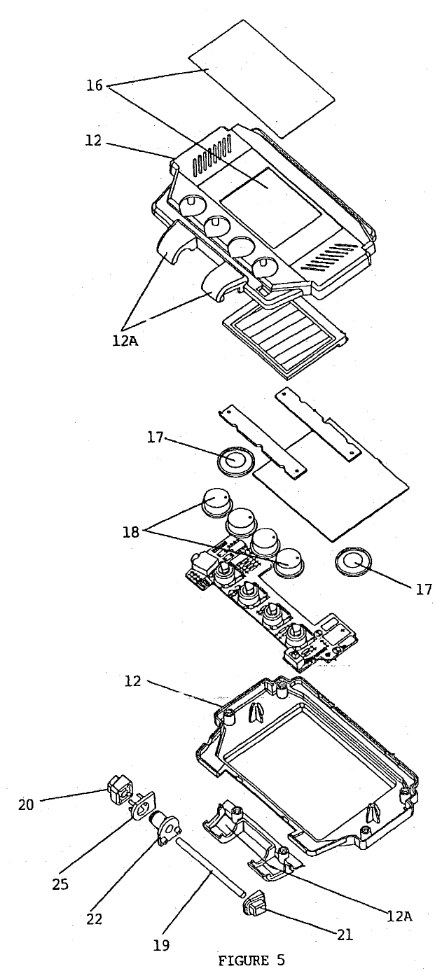

The hinge 13 includes a horizontal shaft 19 housed therein, which extends along the hinge axis. Two pushbuttons 20 and 21 are connected co-axially to opposite left and right ends of the shaft 19. The pushbuttons 20 and 21 are used to slide the shaft 19 left or right to either lock the display panel 12 in a selected pivotal orientation, or allow movement of it. In FIG. 1 the shaft 19 is shifted to the right to lock against pivotal movement of the display panel 12, whereas in FIG. 2 the shaft 19 is shifted to the left and the display panel 12 is released.

Located about the left end portion of the shaft 19 is a hollow spline component 22 that is fixed against rotation with respect to the base unit 11. This component 22 has a hollow cylindrical portion 23, around an outer end of which longitudinally extending splines 24 are formed.

Positioned about the cylindrical portion 23 is a clamping component 25 that is fixed against rotation with respect to the display panel 12. The clamping component 25 has four longitudinally extending fingers 26 projecting from an outer side thereof. These fingers 26 are parallel to the shaft 19 and extend into a hollow of the pushbutton 20 when the pushbutton 20 is depressed to thereby shift the shaft 19 to the right. There is a ramping interengagement between the fingers 26 and the hollow of the pushbutton 20, which causes the fingers 26 to deform or bend inwardly to thereby bear against and engage with the splines 24 to prevent relative rotation between the spline component 22 and the clamping component 25. As a result, the pivotal orientation of the display panel 12 with respect to the base unit 11 is fixed.

Upon depression of the other pushbutton 21, the fingers 26 are released from the hollow of the pushbutton 20. As a result, the fingers 26 bend away from the splines 24 under their own resilience, thereby enabling pivotal movement of the display panel 12 with respect to the base unit 11.

There are electrical conductors, for example in the form of a ribbon cable or flex-film, passing through the hinge structure from the base unit 11 to the display panel 12 for delivering video signals thereto.

As shown in FIG. 6, there might be a single cord 29 extending from the base unit 11 to a boxed junction 27. Electrical power from a transformer 28 can be delivered via the junction 27 and cord 29 to the control unit 10. A game console 30 has a game port 31 and an AV adapter 32. A control signal cord 33 extending from the junction 27 passes control signals from the controller 10 via cord 29 to the game port 31 of the console 30. Audio and video signals for reproduction and display at the display panel 12 are transmitted to the control unit 10 via an audio/video cable 34, the junction 27 and cord 29. As an alternative to the specific network structure depicted in FIG. 6, the console 30 might have infrared receiving and transmitting devices and the controller 10 might also have infrared receiving and transmitting devices for communication therewith.

Moreover, the controller 10 is not limited to use with the Sony PlayStation 2®, and any other game consoles and future game consoles may be employed. Also, instead of cables or infrared transmission, RF transmission or other means of transmission are envisaged.

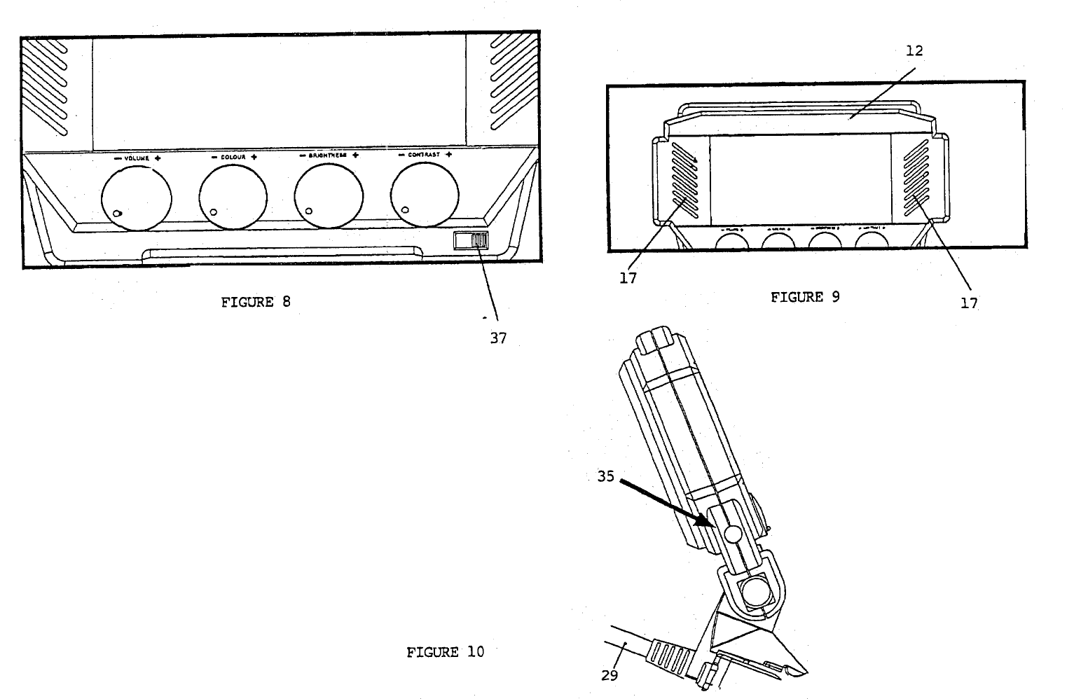

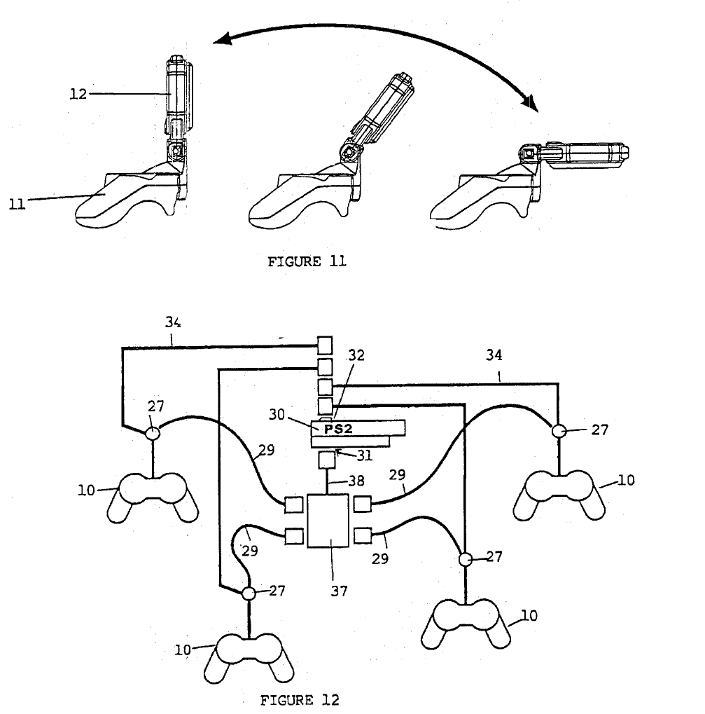

There is a phone jack 35 at one side of the display panel 12 (FIG. 10) to which headphones or earphones can be connected. The phone jack 35 would have associated with it a speaker out of circuit featuring to disable the stereo speakers 17 when headphones or earphones are used. At the bottom right corner of the display unit 12, a power on/off switch 37 is provided for switching off the display unit 12 when it is not in use.

A four-player system shown in FIG. 12 may comprise a multi-tap 37 to which the cord 29 of each of the control units 10 is connected. A single control cord 38 from the multi-tap 37 is connected to the game port 31 of the game console 30. Also, there may be attached to the AV adapter 32 of the console 30 a piggy-backed interconnection of audio/video cables 34 via which audio and video signals are relayed to the respective control units 10.

It should be appreciated that modifications and alterations obvious to those skilled in the art are not to be considered as beyond the scope of the present invention. For example, the display panel 12 need not be pivotable with respect to the base unit 11 and the control unit 10 itself is not limited in its application to Sony PlayStation 2®.

1. A handheld video game control unit, comprising:
user-manipulable controls,
a control signal output via which control signals generated by the controls are transmitted by the unit to a game console,
a display panel, and
an input via which the display panel receives video signals from an external source.

2. The control unit of claim 1, further comprising speakers and/or an earphone/headphone jack for audio signals received via said or another input.

3. The control unit of claim 1, further comprising a base unit to which the display panel is attached by a pivot connection.

4. The control unit of claim 3, wherein there is associated with the pivot connection a locking device for locking the display panel at one of a number of selected orientations with respect to the base unit.

5. The control unit of claim 4, including a shaft between the display panel and the base unit, a clutching device for locking the display panel against pivotal movement with respect to the base unit, and a pushbutton at each end of the shaft by which the shaft is movable longitudinally to operate the clutching device to enable pivotal movement of the display panel with respect to the base unit.

6. The control unit of claim 5, wherein the clutching device comprises a spline fixed relative to one of the base unit and display panel and a number of clutching fingers fixed relative to the other of the display panel and base unit and engageable with one of the pushbuttons to bear against the spline when the shaft is moved longitudinally.

7. A video game system comprising:
the control unit of any one of the preceding claims, and
a game console having a video output transmitting video information to the input of the control unit, and a control signal input receiving control signals from the control signal output of the control unit.
